(19) United States
(12) Patent Application Publication
(10) Pub. No.: US 2025/0074438 A1
(43) Pub. Date: Mar. 6, 2025

(54) MODEL GENERATION METHOD

(71) Applicant: TOYOTA JIDOSHA KABUSHIKI KAISHA, Aichi-ken (JP)

(72) Inventors: Yuki TAKAHASHI, Miyoshi-shi (JP); Masateru UDATE, Tokyo-to (JP); Takeki MORI, Tokyo-to (JP)

(21) Appl. No.: 18/815,842

(22) Filed: Aug. 27, 2024

(30) Foreign Application Priority Data
Aug. 31, 2023 (JP) 2023-141491

(51) Int. Cl. B60W 50/029

(52) U.S. Cl. CPC B60W 50/029

(57) ABSTRACT

The model generation device according to one aspect of the present disclosure collects defective scene data related to a scene that is evaluated as insufficient performance during operations of automatic control using a control model of a mobile body, generates a patch model for supplementing a performance of the control model for the scene evaluated as insufficient performance from the collected defective scene data, and outputs the generated patch model.

### CROSS REFERENCE TO THE RELATED APPLICATION

This application claims the benefit of Japanese Patent Application No. 2023-141491, filed on Aug. 31, 2023, which is hereby incorporated by reference herein in its entirety.

### BACKGROUND

### Technical Field

The present disclosure relates to a model generation method.

### Description of the Related Art

Japanese Patent Laid-Open No. 2019-533810 (hereinafter referred to as “Patent Document 1”) proposes a system for autonomous vehicle control configured to determine vehicle commands from routes, GPS data, and sensor data using a trained neural network.

### SUMMARY

One of the objects of the present disclosure is to provide a technique for improving the performance of a control model used for automatic control of a mobile body in a simple manner.

A model generation method according to a first aspect of the present disclosure is to be executed by a computer. The model generation method comprises collecting defective scene data related to a scene that is evaluated as insufficient performance during operations of automatic control using a control model of a mobile body, generating a patch model for supplementing a performance of the control model for the scene evaluated as insufficient performance from the collected defective scene data, and outputting the generated patch model. The patch model may be configured by a neural network, and machine learning such as deep learning may be used as a method for generating the patch model.

According to the present disclosure, it is possible to improve the performance of the control model used in the automatic control of the mobile body in a simple manner.

### BRIEF DESCRIPTION OF THE DRAWINGS

FIG. 1 schematically indicates an example of a situation in which the present disclosure is applied.

FIG. 2 schematically indicates an example of the form of the patch model of the present disclosure.

FIG. 3 schematically indicates an example of the form of the patch model of the present disclosure.

FIG. 4 schematically indicates an example of the hardware configuration of the model generation device of the present disclosure.

FIG. 5 indicates an example of a processing procedure related to model generation of the present disclosure.

### DESCRIPTION OF THE EMBODIMENTS

Conventionally, rule-based autonomous driving systems are known. Further, according to the method of Patent Document 1 and the like, an autonomous driving system can be constructed by using a trained machine learning modeled. However, the present inventors have found that these conventional methods have the following problems. For example, the traffic network (road conditions) may change in the short term due to construction, weather, traffic volume, etc. In addition, the traffic network may be constantly changed due to factors such as the addition of new roads and changes in regulations. Since traffic conditions can vary due to a variety of factors, it is difficult to generate a control model that is fully adaptable to all scenes in either a rule-based or machine-learning model. Therefore, the control model used for vehicle control (autonomous driving) is required to be updated as appropriate. However, the structure of the control model can be complicated because the control command is derived in consideration of various circumstances such as location, route, and surrounding environment. Therefore, it can take time to update the control model. In one example, updating the control model to address a scene with insufficient performance may result in insufficient performance in another scene where control commands could be appropriately derived before the update. It can take time to verify the performance of the control model so that such a situation does not occur. That is, it is difficult to quickly improve the performance of the control model at low cost in the method of updating the control model. This problem point can occur regardless of the type of vehicle. Moreover, such problems do not occur only in situations where the vehicle is being controlled. The same is true for moving bodies other than vehicles in terms of controlling movement. Therefore, the same problem can occur in the scene of controlling any mobile body other than the vehicle.

On the other hand, a model generation method according to a first aspect of the present disclosure is to be executed by a computer. The model generation method comprises collecting defective scene data related to a scene that is evaluated as insufficient performance during operations of automatic control using a control model of a mobile body, generating a patch model for supplementing a performance of the control model for the scene evaluated as insufficient performance from the collected defective scene data, and outputting the generated patch model.

In the first aspect of the present disclosure, to deal with a scene that is evaluated as insufficient performance of the control model, a patch model is generated to supplement the performance of the control model rather than updating the control model itself. This patch model can be generated more simply than the control model itself, since it only needs to be able to deal with the scene evaluated as insufficient performance. Therefore, according to the present disclosure, it can be expected to improve the performance of the control model in a simple manner.

As another form of the model generation method (information processing method) relating to the above aspect, one aspect of the present disclosure may be an information processing device that realizes all or part of the above components, or may be a program, or may be a storage medium (non-transitory computer readable medium) that stores such a program and is readable by a machine such as a computer. Here, a machine-readable storage medium is a medium in which information such as a program is stored by an electrical, magnetic, optical, mechanical, or chemical action. Furthermore, one aspect of the present disclosure may be a control device (information processing device) that uses the generated patch model, an information processing method, a program, or a storage medium that stores such a program.

### 1 Application Example

FIG. 1 schematically indicates an example of a scene in which the present disclosure is applied. The model generation device 1 according to the present embodiment is one or more computers configured to generate a patch model 5. In the present embodiment, the model generation device 1 collects defective scene data 4 related to a scene evaluated as insufficient performance during operation of automatic control using the control model 3 of the mobile body M. The model generation device 1 generates a patch model 5 for supplementing a performance of the control model 3 for the scene evaluated as insufficient performance from the collected defective scene data 4. Then, the model generation device 1 outputs the generated patch model 5.

In one example, it may take time to verify the performance of the updated control model. In another example, it may take time and cost to collect training data for a scene with insufficient performance so as not to be buried in the training data of the existing scene. Therefore, it is difficult to quickly improve the performance of the control model by updating the control model. On the other hand, in the present embodiment, to deal with a scene that is evaluated as insufficient performance of the control model 3, a patch model 5 is generated for supplementing the performance of the control model 3 rather than updating the control model 3 itself. Since the patch model 5 only needs to be able to deal with scenes that are evaluated as insufficient performance, it can be easily generated compared to the control model 3 itself. For the same reason, it may also be possible to collect less data (defective scene data 4). Therefore, according to the present embodiment, it can be expected that the performance of the control model 3 will be improved by a simple method.

### (Mobile Body)

If it can be moved automatically by mechanical control, the type of mobile body M may be appropriately selected according to the embodiment. The mobile body M may be, for example, a movable device such as a vehicle, a flying body, a ship, a robot device, etc. The flying body may be at least one of an unmanned aircraft such as a drone and a manned aircraft. In one example, as shown in FIG. 1, the mobile body M may be a vehicle. The type of vehicle (number of wheels, power source, size, etc.) may be arbitrarily selected. As an exemplary example, the mobile body M may be an automobile having a level 2 or higher autonomous driving ability.

### (Control Model)

The control model 3 is constructed to derive a control command according to the environment of the mobile body M. The environment is an event observed in at least one of the mobile body M itself and its surroundings. In one example, at least some of the environment may be observed by one or more sensors S located inside or outside the mobile body M. If the sensor S can observe any moving environment of the mobile body M, the type may not be particularly limited, and may be appropriately selected according to the embodiment. In one example, one or more sensors S may include a camera (image sensor), a radar, a LiDAR (Light Detection And Ranging), a sonar (ultrasonic sensor), an infrared sensor, a GNSS (Global Navigation Satellite System)/GPS (Global Positioning Satellite) module, and the like.

If the control command can be derived from the environment of the mobile body (mobile body M), the input/output form of the control model 3 may not be particularly limited, and may be appropriately selected according to the embodiment. In one example, the control model 3 may be configured to derive a control command from the observation data of one or more time points of the sensor S. In another example, the control model 3 may be configured to derive a control command from the recognition result of the surrounding environment. The recognition result of the surrounding environment may be obtained by analyzing the observation data of the sensor S by an arbitrary method (that is, using an analysis model). The analysis model may be appropriately configured to infer the recognition result of the surrounding environment from the observation data of the sensor S. In one example, the analysis model may be configured to obtain recognition results of the surrounding environment from observation data by rule-based by executing analysis processes such as pattern matching and edge detection. In another example, the analysis model may be configured by a trained machine learning model. The analysis model may be considered as a part of the control model 3 or may be regarded as a separate component from the control model 3. Other information may optionally be added to the input of the control model 3. The control model 3 may be configured to further accept input of arbitrary information, for example, set speed, speed limit, movement state data, map data, navigation information (route data), etc. When the mobile body M is a vehicle, the optional information (moving state data) may include travel data. Arbitrary information may be appropriately acquired from a device such as a navigation device, an in-vehicle sensor, or the like.

Further, the control model 3 may be configured to directly output a control command or may be configured to output a control command indirectly. In the latter case, a control command may be obtained by executing arbitrary information processing (for example, interpretation processing such as determination, selection, or the like) on the output of the control model 3. If the operation of the mobile body M can be controlled, the form of the control command may not be particularly limited, and may be appropriately determined according to the embodiment. The control command may be configured to directly indicate the control amount (control indication value, control output amount) of the mobile body M, for example, gas pedal control amount, brake control amount, steering wheel steering angle, etc. Alternatively, the control command may be configured to indirectly indicate the control amount of the mobile body M, such as a path, a state after control, and the like. In this case, by executing arbitrary information processing, the control amount of the mobile body M may be obtained from the control command. In one example, when the mobile body M is a vehicle, the control amount of the vehicle may be obtained by applying the inference result obtained from the control model 3 to the vehicle model. The vehicle model may have various parameters such as accelerator, brake, steering wheel, etc., and may be appropriately configured to derive a control amount from indirect information (path, post-control state, etc.). When the control command is represented by a path, the control model 3 may be expressed as a path planner. Further, the control command may further include a command related to the operation of the mobile body M. As an example, when the mobile body M is a vehicle, the control command may include vehicle operations such as turn signals, hazards, horns, communication processing (for example, transmitting data to a center, sending an emergency call, etc.). The output format of the control model 3 may be appropriately changed according to the embodiment.

The configuration of the control model 3 may be appropriately selected according to the embodiment. In one example, the control model 3 may comprise a trained machine learning model (e.g., an end-to-end model), a rule-based model, or a combination thereof. The rule-based model is configured to match a given input (for example, information indicating the environment such as observation data and recognition results of the surrounding environment) to a rule, and derive a control command according to the result of the matching (according to the matching rule). The rule may be set manually or at least partially automatically. The machine learning model is configured to have one or more operational parameters that can be adjusted by machine learning. One or more operational parameters are used to calculate the desired inference (in the present disclosure, the derivation of control commands). Machine learning involves adjusting (optimizing) the values of computational parameters by using training data. The machine learning model may be configured by, for example, a neural network, a support vector machine, a regression model, a decision tree model, and the like. The machine learning method may be appropriately selected according to the machine learning model employed (for example, error backpropagation method, etc.). Machine learning may include supervised learning, unsupervised learning, and reinforcement learning. Typically, when supervised learning is employed, the learning data may comprise multiple data sets each including a combination of training data and ground truth data.

As an example, the control model 3 may be configured by a neural network. The structure of the neural network may be appropriately determined according to the embodiment. The structure of the neural network may be specified, for example, by the number of layers from the input layer to the output layer, the type of each layer, the number of nodes (neurons) included in each layer, the connection relationship between nodes in each layer, and the like. In one example, the neural network may have a recursive structure. Further, the neural network may include an arbitrary layer such as a fully connected layer, a convolutional layer, a pooling layer, a deconvolutional layer, an unpooling layer, a normalization layer, a dropout layer, and an LSTM (Long short-term memory). The neural network may have an arbitrary mechanism such as an Attention mechanism. The neural network may include any model such as a GNN (Graph neural network), a diffusion model, a generative model (for example, a Generative Adversarial Network, a Transformer, etc.). When the neural network is used for the control model 3, the coupling weights between each node included in the control model 3 and the threshold value of each node are examples of operational parameters. When the machine learning model is employed, the control model 3 may be configured with an end-to-end model structure. The control model 3 may be prepared for each movement type, such as lane change, lane keeping, emergency stop (EDSS: Emergency Driving Stop System), etc., for example.

### (Operation of Automatic Control)

In the mobile body M, automatic control using the control model 3 may be appropriately operated. In one example, the control device 2 may be used for the operation of the automatic control. The control device 2 may be configured to directly control the operation of the mobile body M, or may be configured to control indirectly via an external device (for example, a controller, etc.).

The control process may be appropriately determined according to the configuration of the control model 3. In one example, the control device 2 may acquire observation data directly or indirectly from the sensor S. The control device 2 may provide at least a part of the acquired observation data to the control model 3 and perform the arithmetic processing of the control model 3 (matching rules, arithmetic processing of the machine learning model, etc.). Thereby, the control device 2 may acquire the derivation result of the control command. Then, the control device 2 may execute automatic control of the mobile body M according to the derived control command.

The control device 2 may be deployed at any location. In one example, as shown in FIG. 1, the control device 2 may be mounted on the mobile body M. The mounting location may be arbitrarily determined, for example, the control device 2 may be attached to the inside or outside of the mobile body M. In another example, the control device 2 may be located away from the mobile body M and configured to remotely control the mobile body M. The control device 2 may be connected to the mobile body M by wire or wirelessly.

The control model 3 may be appropriately provided to the control device 2. The control model 3 may be provided to the control device 2 via a network, storage medium, or the like, or may be incorporated in advance into the control device 2. When generating a patch model 5 in each mobile body M, the control device 2 may also serve as the model generation device 1.

### (Insufficient Performance)

The insufficient performance of the control model 3 may be evaluated in any way. In one example, the insufficient performance may include evaluation of defects, inadequacies, defects, poor, undesirable (there is a desire to obtain a more preferred control command) or a combination thereof. The insufficient performance may be evaluated in the control device 2 while controlling the movement of the mobile body M according to the control command derived by the control model 3. Further, the insufficient performance may be evaluated in at least one of the real environment and the virtual environment (simulation).

The insufficient performance of the control model 3 may be specified by, for example, user reporting (near-misses, hearings, reports), manual intervention by the user for automatic control, detection by data analysis (pattern detection, data deviation), and the like. The defective scene data 4 may also be collected from scenes with similar environments, such as geographical proximity and similar path attributes (curvature of curves, surrounding environment, etc.). That is, the scene evaluated as insufficient performance may include such similar scenes. In the following description, for convenience, a scene evaluated as insufficient performance is also referred to as a “insufficient performance scene”.

### (Defective Scene Data)

To generate the patch model 5, the defective scene data 4 may include arbitrary information that can identify a scene that is evaluated as insufficient performance. The items of information may be appropriately selected according to the embodiment. In one example, the defective scene data 4 may include moving environment data indicating the moving environment (condition/situation) in the scene evaluated as insufficient performance. The moving environment data may include information such as location, route, and surrounding environment. The moving environment data may include, for example, observation data of the sensor S provided in the mobile bodyM. The moving environment data may include recognition results of the surrounding environment. When evaluating insufficient performance due to user intervention, the defective scene data 4 may include an operation of intervention by the user or a control command by the operation.

The collection method of the defective scene data 4 may be appropriately selected according to the embodiment. The defective scene data 4 may be appropriately collected from at least one of the real environment and the virtual environment. For the collection of defective scene data 4, the mobile body M (control device 2) may be appropriately utilized. In one example, when insufficient performance is detected in a particular environment, the model generation device 1 or an external server may give a command to collect defective scene data 4 to a mobile body M (control device 2) moving in a specific environment or an environment similar to it via a network. In response to this, the control device 2 of the mobile body M may acquire the defective scene data 4 in real time when moving a specific environment or an environment similar thereto, and the acquired defective scene data 4 may be appropriately reported to the model generation device 1 or an external server. Note that the insufficient performance in a particular environment may be detected by a predetermined number of user reports, user interventions, data analysis, and the like.

Further, a control command (ground truth data) conforming to the scene may be appropriately given for the defective scene data 4. The control command that adapts to the scene may be given, for example, as a result of an intervention operation, manually given after the fact, or given by computer processing. When the defective scene data 4 includes an intervention operation by the user or a control command by the operation, the intervention operation included in the defective scene data 4 or the control command by the operation may be used as ground truth data as it is, or arbitrary modifications (such as averaging) may be applied and may be adopted as ground truth data. Note that the ground truth data may be provided in a form of integration (addition, subtraction, etc.) with respect to the output of the control model 3, or may be given in a form of substitution.

### (Patch Model)

The patch model 5 may be configured by a trained machine learning model, a rule-based modeled, or a combination thereof, as well as the control model 3. The patch model 5 is configured to be able to derive appropriate control commands in the environment indicated by the defective scene data 4 (including moving environment data) without changing the existing portion of the control model 3 together with or in place of the control model 3. If so configurable, the form of the patch model 5 may not be particularly limited and may be appropriately selected according to the embodiment. In one example of the present embodiment, at least one of the following two forms may be employed.

### (I) First Form

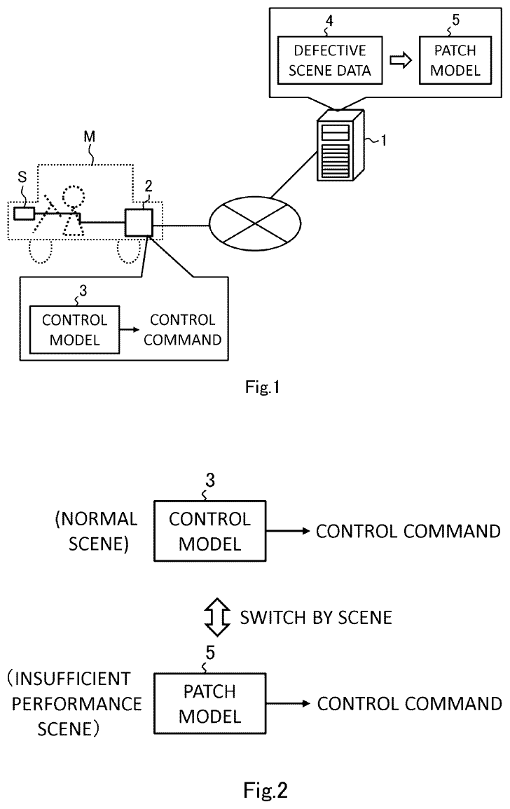

FIG. 2 schematically indicates an example of the first embodiment of the patch model 5 of the present disclosure. In the first embodiment, the patch model 5 does not change the existing portion of the control model 3 deployed on the mobile body M, and may be a new control model that coexists separately with the control model 3 and is used only in scenes where insufficient performance is evaluated. The new control model (patch model 5) may be configured so that a control command suitable for the scene evaluated as insufficient performance can be derived by using the defective scene data 4.

using only in insufficient performance scene may include at least one of switching to (replacing) the control model 3 and using the patch model 5 in insufficient performance scene, and not using the patch model 5 other than in insufficient performance scene and using the patch model 5 together with the control model 3 in insufficient performance scene. When the former form is adopted, supplementing the performance of the control model 3 may comprise using the control command derived by the patch model 5 instead of the control command derived by the control model 3. When the latter form is adopted, supplementing the performance of the control model 3 may comprise modifying the control command derived by the control model 3 with the patch model 5. In one example, modifying the control command may be configured by integrating the control command derived by the patch model 5 into the control command derived by the control model 3. According to the first embodiment, the performance of the control model 3 can be appropriately supplemented by deploying a new control model used only for the scene where performance is insufficient performance as a patch model 5.

### (II) Second Form

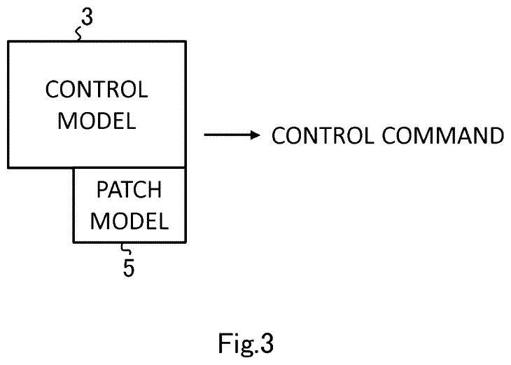

FIG. 3 schematically indicates an example of the second embodiment of the patch model 5 of the present disclosure. In the second embodiment, the patch model 5 may be deployed to expand an output portion of the control model 3 without changing the existing portion of the control model 3, and the expanded output portion may be configured to derive a control command that conforms to the scene evaluated as insufficient performance.

Not changing the existing portion means not changing the value of the parameter of the existing part. However, when both the control model 3 and the patch model 5 are configured by a machine learning model, the connection relationship of the existing portion may be modified in order to connect the patch model 5 to the control model 3. For example, when the control model 3 is composed of a neural network, in at least one of the layers from the input layer to the output layer of the control model 3, a connection may be added to a node in an existing part in order to input the output of that layer to the patch model 5.

The form of the expansion (addition) may be appropriately selected according to the embodiment. In one example, when the control model 3 is configured by a neural network, the expansion may be configured by adding nodes in any layer from the input layer to the output layer of the control model 3. For example, at least an output layer node may be added (FIG. 3). The output form of the added node may be appropriately selected according to the embodiment. For example, the added node may be configured to output the amount of modification of the control command in a scene with insufficient performance, and to output arbitrary information (for example, meaningless information) in other scenes. In this case, supplementing the performance of the control model 3 may comprise modifying the control command derived by the control model 3 with the patch model 5. Also, for example, the added node may be configured to derive a control command that matches the insufficient performance deficiency scene. In this case, supplementing the performance of the control model 3 may comprise using the control command derived by the patch model 5 instead of the control command derived by the control model 3. In another example, the expansion may be configured by adding one or more layers. For example, one or more layers may be added as a patch model 5 after the output layer of the control model 3. The added layer may be configured to modify the output of the control model 3 in a scene with insufficient performance, and output the output of the control model 3 almost as it is in other scenes. In this case, supplementing the performance of the control model 3 may comprise modifying the control command derived by the control model 3 with the patch model 5. According to the second embodiment, the performance of the control model 3 can be appropriately supplemented by deploying a patch model 5 for adding the control model 3.

### (Performance Supplement)

In one example of the present embodiment, when any of the above forms is adopted, supplementing the performance of the control model 3 may be configured by using a control command derived by the patch model 5 instead of a control command derived by the control model 3 or modifying the control command derived by the control model 3 with the patch model 5. According to an example of the present embodiment, the patch model 5 can be used to appropriately supplement the performance of the control model 3.

Whether or not it is a scene with insufficient performance (that is, whether or not it is a scene that uses the patch model 5) may be appropriately determined. In one example, whether or not it is insufficient performance scene may be determined according to the moving environment such as location, route, and surrounding environment. For example, in the mobile body M, it may be determined whether or not the moving environment of the mobile body M is the same as the scene with insufficient performance using observation data obtained in real time during automatic control (the same may include similarity). At least one of the rule-based model and the machine learning model may be used for the discrimination process. In another example, whether or not it is insufficient performance scene may be determined according to the output of at least one of the control model 3 and the patch model 5. For example, the patch model 5 may be configured to output predetermined information such as meaningless information except in insufficient performance scene. Accordingly, it may be determined whether or not it is insufficient performance scene depending on whether or not the output of the patch model 5 is predetermined information. Further, for example, the patch model 5 may be configured to further output information for discrimination such as reliability and score, and may determine whether or not it is insufficient performance scene according to this information.

### (Patch Model Generation)

The patch model 5 may be appropriately generated from the defective scene data 4. The patch model 5 may be automatically generated by computer processing or may be generated at least partially via human hands.

When at least a part of the patch model 5 is configured by a rule-based model, the rules constituting the patch model 5 may be determined by analyzing the defective scene data 4 in an arbitrary manner. At least some of the rules may be determined or modified manually.

When at least a part of the patch model 5 is composed of a machine learning model, the patch model 5 (trained model) may be generated by machine learning using training data obtained from the defective scene data 4. When the second form is adopted, the machine learning may be configured by fixing the value of the parameter of the existing portion and training (adjusting the value of the parameter) only in the expansion portion (patch model 5). The training data (input data) may be obtained directly from the defective scene data 4, or may be obtained indirectly by applying arbitrary information processing. In one example, the moving environment data may be used as training data. The ground truth data (teacher signal, label) corresponding to the training data is configured so that appropriate control commands can be derived for the scene where the insufficient performance in the training data. Ground truth data may be given accordingly. The ground truth data may be given at least partially.

Note that the computer resource for generating the patch model 5 is not limited to the model generation device 1. Generating the patch model 5 may be configured by at least one of generating inside the model generation device 1, and the model generation apparatus 1 giving instructions to the external computer and generating the patch model 5 on the external computer. The defective scene data 4 may be stored in the memory resources of the model generation device 1 or may be stored in an external computer other than the model generation device 1.

### (Output of Patch Model)

The output form of the patch model 5 may be appropriately selected according to the embodiment. In one example, outputting the patch model 5 may comprise storing the generated patch model 5 in a predetermined storage area. The predetermined storage area may be secured in the memory resource in the model generation device 1, or may be secured in an external computer storage device other than the model generation device 1. The generated patch model 5 may be stored in a format that can be transmitted to each mobile body M (control device 2). In another example, outputting the patch model 5 may include distributing the generated patch model 5 to the control device 2 of each mobile body M. Delivery of the patch model 5 may be performed in any manner. The patch model 5 may be provided to the control device 2 via a network such as the Internet, a wireless communication network, a mobile communication network, a telephone network, or a dedicated network, for example. The patch model 5 may be provided to the control device 2 via a storage medium or the like. When generating a patch model 5 on an external computer, outputting the patch model 5 may include instructing the external computer and causing the external computer to execute at least one of these. Further, when the same computer also serves as the model generation device 1 and the control device 2, the computer generates a patch model 5 by operating as the model generation device 1, and the generated patch model 5 may be used when operating as the control device 2.

Note that the number of patch models 5 generated for one control model 3 may not be limited to one, but may be two or more. Further, after one or more patch models 5 are applied, the control model 3 may be updated as appropriate. When the control model 3 is updated (i.e., a new control model 3 is deployed), the patch model 5 that is no longer needed may be discarded as appropriate. If the insufficient performance continues even after the update of the control model 3, the patch model 5 may continue to be used as it is. Whether to continue using or discarding the patch model 5 may be selected by the user or may be determined by computer processing.

### 2 Configuration Example

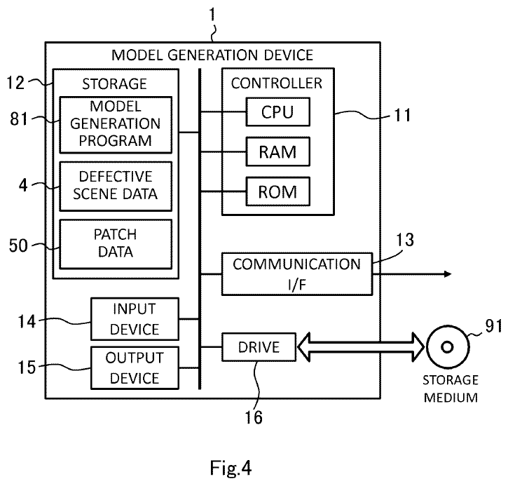

FIG. 4 schematically indicates an example of the hardware configuration of the model generation device 1 according to the present embodiment. The model generation device 1 according to the present embodiment is a computer to which the controller 11, the storage 12, the communication interface 13, the input device 14, the output device 15, and the drive 16 are electrically connected.

The controller 11 includes a CPU (Central Processing Unit), RAM (Random Access Memory), ROM (Read Only Memory), and the like, and is configured to execute arbitrary information processing based on a program and various data. The controller 11 (CPU) is an example of a processor resource. The storage 12 may be configured of, for example, a hard disk drive, a solid-state drive, or the like. The storage 12 (and RAM, ROM) is an example of a memory resource. In the present embodiment, the storage 12 stores various information such as a model generation program 81, defective scene data 4, and patch data 50.

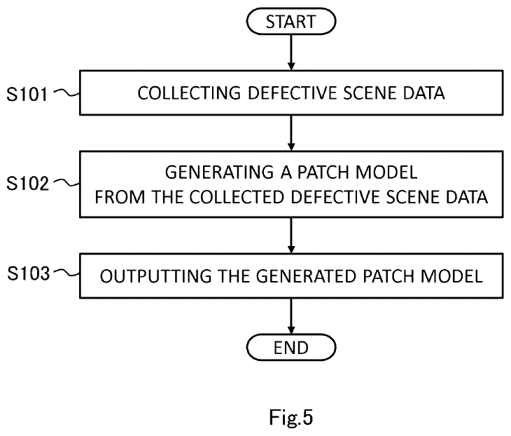

The model generation program 81 is a program for causing the model generation device 1 to execute information processing (FIG. 5 described later) for generating the patch model 5. The model generation program 81 includes a series of instructions for the information processing. The patch data 50 is configured to indicate information about the patch model 5. The patch data 50 may be appropriately configured to include information for reproducing the patch model 5. In one example, if the patch model 5 is configured by a machine learning model, the patch data 50 may include information indicating the value of the operational parameter adjusted by machine learning. Optionally, the patch data 50 may further include information indicating the configuration of the machine learning model (e.g., the structure of a neural network, etc.). In another example, if the patch model 5 is configured by a rule-based model, the patch data 50 may include information indicating a rule-based model (rule). In the present embodiment, the patch data 50 is generated as a result of executing the model generation program 81.

The communication interface 13 is an interface for performing wired or wireless communication via a network. The communication interface 13 may be configured by, for example, a wired LAN (Local Area Network) module, a wireless LAN module, or the like. The model generation device 1 may perform data communication with another computer (for example, the control device 2) via the communication interface 13. The input device 14 is, for example, a device for performing input such as a mouse, a keyboard, an operator, and the like. The output device 15 is a device for outputting a display, a speaker, or the like, for example. The operator can operate the model generation device 1 by using the input device 14 and the output device 15. The input device 14 and the output device 15 may be integrally configured by, for example, a touch panel display or the like.

The drive 16 is a device for reading various information such as a program stored on the storage medium 91. At least one of the model generation program 81, the defective scene data 4, and the patch data 50 may be stored on the storage medium 91 instead of or together with the storage 12. The storage medium 91 is configured to store the information by electrical, magnetic, optical, mechanical or chemical action so that a machine such as a computer can read various information (such as a stored program). The model generation device 1 may acquire at least one of the model generation program 81 and the defective scene data 4 from the storage medium 91. The storage medium 91 may be a disk-type storage medium such as a CD or DVD, or a storage medium other than a disk-type such as a semiconductor memory (for example, flash memory). The type of drive 16 may be appropriately selected according to the type of storage medium 91.

With regard to the specific hardware configuration of the model generation device 1, the component can be omitted, replaced, and added as appropriate according to the embodiment. For example, the controller 11 may include a plurality of hardware processors. Hardware processor includes microprocessor, field-programmable gate array (FPGA), digital signal processor (DSP), electronic control unit (ECU), graphics processing unit (GPU), and application-specific integrated circuit (ASIC) or the like. At least one of the communication interface 13, the input device 14, the output device 15, and the drive 16 may be omitted. At least one of the input device 14, the output device 15, and the drive 16 may be connected via an external interface or a communication interface 13. The external interface may be configured for wired or wireless connection to external devices, for example, by a USB (Universal Serial Bus) port, dedicated port, wireless communication port, or the like. The defective scene data 4 may be stored in an external computer (for example, NAS: Network Attached Storage, etc.) accessible by the model generation device 1 instead of the storage unit 12. The model generation device 1 may be configured by a plurality of computers. In this case, the hardware configuration of each computer may or may not match. The model generation device 1 may be a general-purpose server device, a general-purpose PC (Personal Computer), an industrial PC, a terminal device (for example, a tablet PC, etc.), in addition to a computer designed exclusively for the service provided.

### 3 Operation Example

FIG. 5 is a flowchart indicating an example of a processing procedure related to the generation of a patch model 5 by the model generation device 1 according to the present embodiment. The controller 11 of the model generation device 1 executes instructions included in the model generation program 81 by the CPU. Thereby, the model generation device 1 operates as a computer capable of executing the following information processing. The following processing steps are an example of a model generation method executed by a computer. However, the following processing procedure is only an example, and each step may be modified as much as possible. Further, the following processing steps can be omitted, replaced, and added as appropriate according to the embodiment.

In step S101, the controller 11 collects defective scene data 4 related to the scene evaluated as insufficient performance during the operation of automatic control using the control model 3 of the mobile body M. In one example, the model generation device 1 may be directly or indirectly connected to the control device 2 of each mobile body M via a network, and the controller 11 may acquire at least a part of the defective scene data 4 from each control device 2 in real time. When the control device 2 also serves as the model generation device 1, the controller 11 may collect defective scene data 4 while operating the control model 3. In another example, the controller 11 may acquire at least a portion of the defective scene data 4 (from the data already collected) from at least one of the storage 12, the storage medium 91, and the external computer. When the defective scene data 4 is acquired, the controller 11 proceeds to the next step S102.

In step S102, the controller 11 generates a patch model 5 using the collected defective scene data 4. When at least a part of the patch model 5 is configured by a rule-based model, generating the patch model 5 may include analyzing the defective scene data 4 and determining the derivation rules of the control command for the scene with insufficient performance. If at least a part of the patch model 5 is configured by a machine learning model, generating the patch model 5 may include performing machine learning using training data obtained from the defective scene data 4. The structure of the machine learning model may be determined accordingly. Machine learning may include additional learning or relearning. When the patch model 5 is generated, the controller 11 proceeds to the next step S103.

In step S103, the controller 11 outputs the generated patch model 5. In one example, the controller 11 generates information related to the generated patch model 5 as patch data 50. The controller 11 may store the generated patch data 50 in a predetermined storage area. For example, a predetermined storage area may be secured in at least one of the storage 12, the storage medium 91, and the external computer. The patch data 50 may be stored in a predetermined storage area accessible from the control device 2 of each mobile body M. The patch data 50 may be provided to the control device 2 at any timing and method. When constructing a new mobile body M, the patch model 5 (patch data 50) may be incorporated in the control device 2 in advance together with the control model 3. In another example, the controller 11 may distribute the patch data 50 to the control device 2 of each mobile body M via the network. When the control device 2 also serves as the model generation device 1, the generated patch model 5 may be appropriately operated for automatic control. When the generated patch model 5 is output, the controller 11 terminates the processing procedure of the model generation device 1 according to the present operation example.

The controller 11 may update or generate new patch data 50 by repeatedly executing the processing of steps S101˜S103 periodically or irregularly. During this repetition, at least a part of the defective scene data 4 may be changed, modified, added, deleted, or the like appropriately executed. Then, the controller 11 may update the patch model 5 held by the control device 2 or deploy a new patch model 5 by providing the updated or newly generated patch data 50 to the control device 2 in an arbitrary manner.

### [Features]

In the present embodiment, the patch model 5 generated by the process of step S102 only needs to be able to deal with scenes that are evaluated as having insufficient performance. Therefore, the patch model 5 may be simpler than the control model 3 itself. In one example, simplicity may comprise at least one of limited performance and simplified structure. Further, for the same reason, in step S101, it is a probability that the amount of defective scene data 4 collected is small. Therefore, according to the present embodiment, it can be expected that the performance of the control model 3 will be improved by a simple method.

### 4 Modifications

As described above, embodiments of the present disclosure have been described in detail, but the description up to the above is only an example of the present disclosure in all respects. Needless to say, various improvements or modifications can be made without departing from the scope of the present disclosure. The processes and means described in the present disclosure can be freely combined and implemented insofar as no technical contradictions arise.

What is claimed is:

1. A model generation method to be executed by a computer, the model generation method comprising:
collecting defective scene data related to a scene that is evaluated as insufficient performance during operations of automatic control using a control model of a mobile body;
generating a patch model for supplementing a performance of the control model for the scene evaluated as insufficient performance from the collected defective scene data; and
outputting the generated patch model.

2. The model generation method according to claim 1,
wherein the patch model is a new control model that coexists separately from the control model deployed on the mobile body and is used only in scenes where insufficient performance is evaluated.

3. The model generation method according to claim 1,
wherein the patch model is deployed to expand an output portion of the control model without changing an existing portion of the control model, and
the expanded output portion is configured to derive a control command that conforms to the scene evaluated as insufficient performance.

4. The model generation method according to claim 1,
wherein the supplementing the performance of the control model comprises:
using a control command derived by the patch model instead of a control command derived by the control model, or
modifying the control command derived by the control model with the patch model.

5. The model generation method according to claim 1,
wherein the mobile body is a vehicle.
